(19) United States
(12) Patent Application Publication
(10) Pub. No.: US 2026/0111554 A1
(43) Pub. Date: Apr. 23, 2026

(54) SECURE FACTORY PROVISIONING OF INFORMATION HANDLING SYSTEMS

(71) Applicant: Dell Products L.P., Round Rock, TX (US)

(72) Inventors: Michael Rash, Mount Airy, MD (US); Marshal F. Savage, Austin, TX (US); Hongsoon Kwon, Porter Ranch, CA (US)

(73) Assignee: Dell Products L.P., Round Rock, TX (US)

(21) Appl. No.: 18/919,601

(22) Filed: Oct. 18, 2024

(51) Int. Cl. G06F 21/57; H04L 9/30

(52) U.S. Cl. CPC G06F 21/575; H04L 9/3073; G06F 2221/034

(57) ABSTRACT

An Information Handling System (IHSs) includes one or more processors, where a first of the processors is factory provisioned by a manufacturer of the first processor by burning a key and boot code to the first processor, and where the key and/or boot code may be provided by a manufacturer of the IHS. The IHS also includes a memory device coupled to the first processor. The memory device stores the boot code that, upon loading and execution by the first processor upon initial powering of the first processor for factory provisioning of the IHS, causes the first processor to restrict the first processor to authenticated factory provisioning operations that program resources of the first processor until the first processor is transitioned to a secured manufacturing state. Until this transition to the secured manufacturing state, the key burned in the first processor is used to authenticate received factory provisioning operations.

### FIELD

This disclosure relates generally to Information Handling Systems (IHSs), and more specifically, to secure factory provisioning of IHSs.

### BACKGROUND

As the value and use of information continues to increase, individuals and businesses seek additional ways to process and store information. One option is an Information Handling System (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

IHSs are typically manufactured and factory provisioned at secured facilities. Since such manufacturing and provisioning facilities may be highly secure from a physical standpoint, use of cryptographic security may be overlooked, or deemed unnecessary, during the factory provisioning process. However, malicious actors that are able to compromise a secure manufacturing facility may interject malicious information within the initial factory provisioning steps of a newly manufactured IHS, thus compromising the IHS entirely.

### SUMMARY

In various systems and methods, Information Handling System (IHSs) may include: one or more processors, wherein a first of the processors is factory provisioned by a manufacturer of the first processor by burning a key and boot code to the first processor, wherein the key may be provided by a manufacturer of the IHS and the boot code may be provided by the manufacturer of the IHS or by the manufacturer of the first processor; a memory device coupled to the first processor, the memory device storing the boot code that, upon loading and execution by the first processor upon initial powering of the first processor for factory provisioning of the IHS, causes the first processor to: restrict the first processor to authenticated factory provisioning operations that program resources of the first processor until the first processor is transitioned to a secured manufacturing state; and use the key burned in the first processor to authenticate received factory provisioning operations.

In some embodiments, the operations that program resources of the first processor comprise operations that permanently set one or more one-time programmable fuses of the first processor. In some embodiments, the operations that program resources of the first processor comprise operations that enable or disable a communication interface of the first processor. In some embodiments, the operations that enable or disable a communication interface of the first processor comprise enabling or disabling a JTAG interface supported by the first processor. In some embodiments, the boot code is burned to the first processor by masking the boot code in a ROM of the first processor. In some embodiments, the key comprises a public key of an asymmetric cryptographic keypair controlled by the manufacturer of the IHS. In some embodiments, the key is burned to the first processor by permanently setting one or more one-time programmable fuses of the first processor. In some embodiments, execution of the boot code by the first processor further causes the first processor to detect receipt of a signed operation directing the first processor to load additional boot code. In some embodiments, the first processor is transitioned to the secured manufacturing state upon validation of the additional boot code against a signature included in the signed operation. In some embodiments, the signature included in the signed operation is validated using the key burned to the first processor.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a block diagram depicting certain components of an IHS operable according to various embodiments for supporting secure factory provisioning of the IHS.

FIG. 2 is a block diagram depicting certain components of a processer installed in an IHS, where the processor is operable according to various embodiments for supporting secure factory provisioning of the IHS.

FIG. 3 is a flow chart diagram illustrating certain steps of a process according to various embodiments for factory provisioning of a processor in support of secure factory provisioning of an IHS.

FIG. 4 is a flow chart diagram illustrating certain steps of a process according to various embodiments for secure factory provisioning of an IHS.

### DETAILED DESCRIPTION

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources, such as a Central Processing Unit (CPU) or hardware or software control logic, Read-Only Memory (ROM), and/or other types of nonvolatile memory.

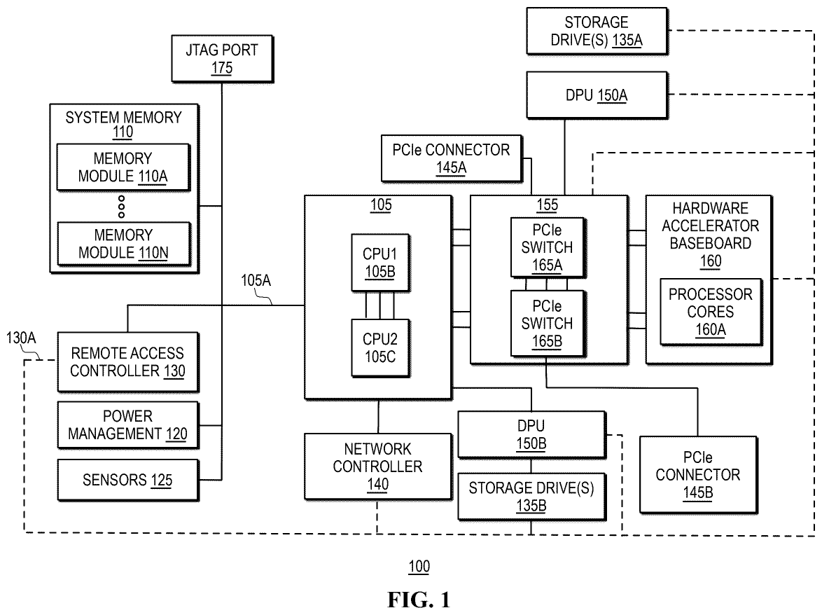

Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below. FIG. 1 shows an example of an IHS configured to implement the systems and methods described herein according to certain embodiments. It should be appreciated that although certain IHS embodiments described herein may be discussed in the context of a personal computing device, such as a rack-mounted server, other embodiments may be utilized.

FIG. 1 is a block diagram illustrating certain components of an IHS 100, according to embodiments, that may be operable according to various embodiments for supporting secure factory provisioning of the IHS. It should be appreciated that although FIG. 1 describes an IHS such as a rack-mounted server, a variety of other types of IHSs may be implemented according to the embodiments described herein. In embodiments, IHS 100 may be factory provisioned by the manufacturer of the IHS using communications that are secured using cryptographic information, such as a cryptographic key, and provisioning instructions that have been burned to the system processor(s) 105 of the IHS, with the provisioning instructions signed with the cryptographic key. In some embodiments, this cryptographic key and provisioning instructions may be provided by the manufacturer of the IHA 100 and burned to the system processors(s) 105 by the manufacturer of a respective processor. In some embodiments, the cryptographic key and/or provisioning instructions burned to a system processor 105 may be provided the manufacturer of that processor, or by another trusted entity.

In some embodiments, IHS 100 may utilize one or more system processors 105, that may also be referred to as CPUs (central processing units). In some embodiments, CPUs 105 may each include a plurality of processing cores that may be separately assigned computing tasks. Each of the CPUs 105 may be individually designated as a main processor and as a co-processor, where such designations may be based on delegation of specific types of computational tasks to a CPU 105. In some embodiments, CPUs 105 may each include an integrated memory controller that may be implemented directly within the circuitry of each CPU 105. In some embodiments, a memory controller may be a separate integrated circuit that is located on the same die as the CPU 105.

As described in additional detail below, one or more of the CPUs 105 installed in IHS 100 may be manufactured and provisioned specifically for the manufacturer of the IHS, where the factory provisioning of a respective CPU 105 burns information for use in provisioning the IHS 100 by its manufacturer. In some embodiments, the manufacturer of the IHS 100 provides the manufacturer of the CPU 105 with a cryptographic key and boot code to be burned in the CPU 105. Once the CPU 105 has been manufactured and provisioned in this manner, the CPU is provided to the manufacturer of the IHS 100 and eventually installed in the IHS 100 during its manufacture. Also as described in additional detail below, each respective CPU 105 may include programmable resources, such as programmable fuses, that are provisioned during manufacture of the 100 IHS. For instance, a respective CPU 105 may include fuses that are permanently set in defined state to store cryptographic information, such as cryptographic keys, for use by the CPU. In some embodiments, hardware registers of the CPU 105 may be permanently and immutably programmed during factory provisioning of the IHS 100 based on such configuration of one-time programmable (OTP) fuses.

As described above, the factory provisioning of newly manufactured devices may be conducted in physically secure facilities and in certain existing manufacturing environments may omit use of cryptographic controls on communications with an IHS used in the factory provisioning of that IHS. Accordingly, a malicious actor that is able to compromise the secure manufacturing facility or otherwise compromise the manufacturing process may have the ability to inject malicious instructions or other information in the factory provisioning process, thus severely compromising the security of the IHS being manufactured before they even leave the manufacturing facility. For instance, the programming of OTP registers during factory provisioning of a device may be compromised such that cryptographic keys controlled by a malicious actor are programmed to these OTP registers.

In embodiments, factory provisioning communications for programming of such CPU resources may be authenticated using cryptographic information and boot code instructions provisioned to the CPU 105 during its manufacture and provisioned specifically for the manufacturer of the IHS 100. As described in additional detail below, the boot code instructions provisioned to the CPU 105 may restrict the operation of the CPU to executing factory provisioning operations that are secured using a keypair corresponding to the cryptographic key burned to the CPU during its provisioning, where such restrictions on CPU 105 operations may remain enforced until the programmable resources of the CPU have been provisioned such that the CPU is now in a cryptographically secure manufacturing state.

Each memory controller may be configured to manage the transfer of data to and from a system memory 110 of the IHS, in some cases using a high-speed memory interface. The system memory 110 is coupled to CPUs 105 via one or more memory buses that provide the CPUs 105 with high-speed memory used in the execution of computer program instructions by the CPUs 105. Accordingly, system memory 110 may include memory components, such as static RAM (SRAM), dynamic RAM (DRAM), NAND Flash memory, suitable for supporting high-speed memory operations by the CPUs 105. In certain embodiments, system memory 110 may combine persistent non-volatile memory and volatile memory.

IHS 100 may utilize a chipset that may be implemented by integrated circuits that are coupled to each CPU 105. All or portions of the chipset may be implemented directly within the integrated circuitry of an individual CPU 105. The chipset may provide the CPU 105 with access to a variety of resources accessible via one or more in-band buses 105a. IHS 100 may also include one or more I/O ports that may be used to couple the IHS 100 directly to other IHSs, storage resources, diagnostic tools, and/or other peripheral components. A variety of additional components may be coupled to CPUs 105 via a variety of busses. For instance, CPUs 105 may also be coupled to a power management unit 120 that may interface with a power system of the chassis in which IHS 100 may be installed. In some instances, CPUs 105 may collect information from one or more sensors 125 via a management bus.

In certain embodiments, IHS 100 may operate using a BIOS (Basic Input/Output System) that may be stored in a non-volatile memory accessible by the CPUs 105. The BIOS may provide an abstraction layer by which the operating system of the IHS 100 interfaces with hardware components of the IHS. Upon powering or restarting IHS 100, CPUs 105 may utilize BIOS instructions to initialize and test hardware components coupled to the IHS, including both components permanently installed as components of the motherboard of IHS 100 and removable components installed within various expansion slots supported by the IHS 200. The BIOS instructions may also load an operating system for execution by CPUs 105. In certain embodiments, IHS 100 may utilize Unified Extensible Firmware Interface (UEFI) in addition to or instead of a BIOS. In certain embodiments, the functions provided by a BIOS may be implemented, in full or in part, by the remote access controller 130.

In some embodiments, IHS 100 may include a TPM (Trusted Platform Module) that may include various registers, such as platform configuration registers, and a secure storage, such as an NVRAM (Non-Volatile Random-Access Memory). The TPM may also include a cryptographic processor that supports various cryptographic capabilities. In IHS embodiments that include a TPM, a pre-boot process implemented by the TPM may utilize its cryptographic capabilities to calculate hash values that are based on software and/or firmware instructions utilized by certain core components of IHS, such as the BIOS and boot loader of IHS 100. These calculated hash values may then be compared against reference hash values that were previously stored in a secure non-volatile memory of the IHS, such as during factory provisioning of IHS 100. In this manner, a TPM may establish a root of trust that includes core components of IHS 100 that are validated as operating using instructions that originate from a trusted source. In some embodiments, the TPM of IHS 100 may be factory provisioned in the same manner described above with regard to CPUs 105, such that the TPM is manufactured such that cryptographic information (e.g., a key) and provisioning instructions provided by the manufacturer of the IHS 100 are burned to a memory of the TPM. As with CPU 105, the operations of TPM may be restricted during factory provisioning of the IHS 100 by these provisioning instructions that are burned to a memory of the TPM, where these restrictions authenticate all factory provisioning commands for programming resources of the TPM, such as hardware registers, with the authentication performed using the cryptographic information burned to the TPM during its manufacture.

In the IHS 100 of FIG. 1, CPUs 105 are used to operate a PCIe switch fabric that is used in the operation of PCIe-compliant devices of the IHS, such as PCIe switches 165a-b, SSD storage drives 135a-b, network controller 140 and hardware accelerator 160. In some embodiments, CPUs 105 may be coupled to a network controller 140, such as provided by a Network Interface Controller (NIC) card that provides IHS 100 with communications via one or more external networks, such as the Internet, a LAN, or a WAN. In some embodiments, network controller 140 may be support network operations by CPUs 105 through a PCIe coupling that is accessible by the chipsets of CPUs 105.

In some embodiments, these PCIe couplings supported by CPUs 105 may also be used to interface with one or more DPUs 150a-b. Each of the DPUs 150a-b may include a programmable processor that may be configured for offloading functions from CPUs 105. In some instances, DPUs 150a-b may be programmed to offload functions that support the operation of devices or systems that are coupled to IHS 100, thus sparing CPUs 105 from a significant number of interrupts required to support these devices coupled to the IHS and gaining efficiency through the use of specialized implementations of these offloaded functions that can be achieved using the programmable logic of the DPUs 150a-b. In other embodiments, DPUs 150a-b may implement operations in support of storage drives 135a-b and other types of devices and may similarly support high-bandwidth PCIe connections with these devices. For instance, in various embodiments, DPUs 150a-b may support high-bandwidth PCIe connections with networking devices in implementing functions of a network switch, compression and codec functions, virtualization operations or cryptographic functions.

In some embodiments, DPUs 150a-b may include a plurality of programmable processing cores and/or hardware accelerators, that may be used to implement functions used to support devices coupled to the IHS 100. DPUs 150a-b may also include one more memory devices that may be used to store program instructions executed by the processing cores and/or used to support the operation of SSD storage drives 135a-b, such as in implementing cache memories and buffers utilized in support of the storage drives. In some embodiments, the processing cores of DPUs 150a-b include ARM (advanced RISC (reduced instruction set computing) machine) processing cores. In other embodiments, the cores of DPUs 150a-b may include MIPS (microprocessor without interlocked pipeline stages) cores, RISC-V cores, or CISC (complex instruction set computing) (i.e., x86) cores.

In some embodiments, the DPUs 150a-b of IHS 100 may be factory provisioned in the same manner described above with regard to CPUs 105, such that a respective DPU 150a-b is manufactured such that cryptographic keys and provisioning instructions are burned to a memory of a respective DPUs. As with CPU 105, the operations of DPUs 150a-b may be restricted during factory provisioning of the IHS 100 by these provisioning instructions, where these restrictions authenticate all factory provisioning commands for programming resources of the DPUs 150a-b, such as hardware registers used in the operation of DPUs 150a-b, with the authentication performed using the cryptographic keys that are burned to a respective DPU 150a-b during its manufacture.

In the IHS 100 of FIG. 1, PCIe switches 165a-b are coupled via PCIe connections to one or more hardware accelerator cores 160a that may be connected to the IHS via one or more hardware accelerators 160. Embodiments may include one or more hardware accelerators 160, where each hardware accelerators 160 may be coupled to one or more of the PCIe switches 165a-b, and where each hardware accelerator 160 may include one or more cores 160a. Each of the cores 1 may be a programmable processing core and/or hardware accelerator that can be configured for offloading certain functions from CPUs 105. For instance, PCIe switches 165a-b may transfer instructions and data for generating video images between one or more cores 160a and CPUs 105. In processing this graphics data, cores 160a, each of which may be individual GPU cores, may include hardware-accelerated processing capabilities that are optimized for performing streaming calculation of vector data, matrix data and/or other graphics data.

In some embodiments, the hardware accelerators 160 of IHS 100 may be factory provisioned in the same manner described above with regard to CPUs 105, such that hardware accelerators 160 are manufactured such a cryptographic key and provisioning instructions are burned to a memory of the hardware accelerator. As with CPU 105, the operations of hardware accelerators 160 may be restricted during factory provisioning of the IHS 100 by these provisioning instructions, where these restrictions authenticate all factory provisioning commands for programming resources of the hardware accelerators 160, such as hardware registers used in the operation of processor cores 160a, with the authentication performed using the cryptographic information burned to the hardware accelerator during its manufacture.

As described, IHS 100 may include a remote access controller 130 that supports remote management of IHS 100 and of various internal components of IHS 100. In certain embodiments, remote access controller 130 may operate from a different power plane from the CPUs 105 and from other components of IHS 100, thus allowing the remote access controller 130 to operate, and management tasks to proceed, while the processing cores of IHS 100 are powered off. As described, various functions provided by the BIOS, including launching the operating system of the IHS 100, may be implemented by the remote access controller 130. In some embodiments, the remote access controller 130 may perform various functions to verify the integrity of the IHS 100 and its hardware components prior to initialization of the operating system of IHS 100 (i.e., in a bare-metal state).

Remote access controller 130 may include a service processor, or specialized microcontroller, that operates management software that provides remote monitoring and administration of IHS 100. Remote access controller 130 may be installed on the motherboard of IHS 100, or may be coupled to IHS 100 via an expansion slot connector provided the IHS. In support of remote monitoring functions, remote access controller 130 may include a dedicated network adapter that may support sideband management connections by remote access controller 130 using wired and/or wireless network technologies.

In some embodiments, remote access controller 130 may support monitoring and administration of various managed devices of an IHS via a sideband bus interface 130a. For instance, messages utilized in device management may be transmitted using I2C sideband bus 130a connections that may be established with each of the managed devices. These managed devices of IHS 100, such as specialized hardware, network controller(s) 240, hardware accelerator 160, hardware accelerator 180, and storage drives 135a-b, may be connected to the CPUs 105 via in-line buses, such as the described PCIe switch fabric, that is separate from the I2C sideband bus 130a connections used by the remote access controller 130 for device management.

In various embodiments, an IHS 100 does not include each of the components shown in FIG. 1. In various embodiments, an IHS 100 may include various additional components in addition to those that are shown in FIG. 1. Furthermore, some components that are represented as separate components in FIG. 1 may in certain embodiments instead be integrated with other components. For example, in certain embodiments, all or a portion of the functionality provided by the illustrated components may instead be provided by components integrated into the one or more processor(s) 105 as a systems-on-a-chip.

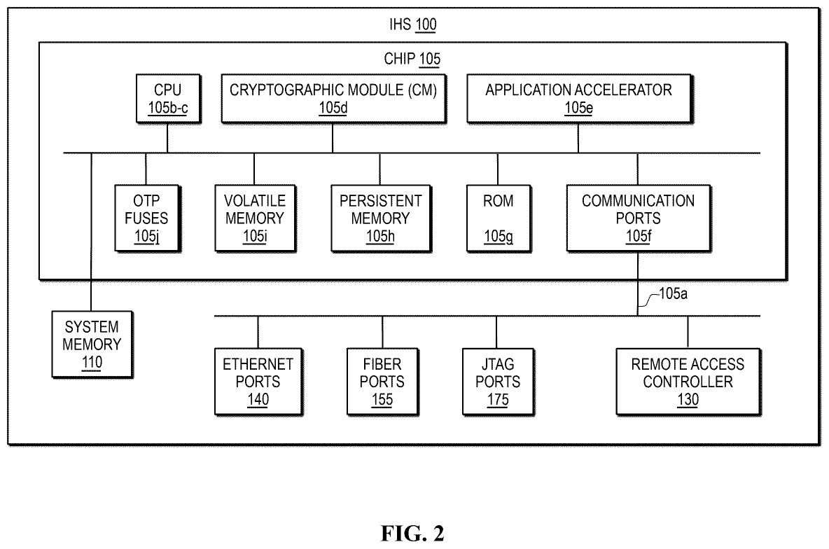

FIG. 2 is a block diagram depicting certain components of a processer installed in an IHS 100 such as described with regard to FIG. 1, where the processor 105 is operable according to various embodiments for supporting secure factory provisioning of the IHS. As described above, an IHS 100 may include one more processors 105 that may execute boot code upon the IHS being powered. Through operation of boot code by processors 105, the IHS 100 may initiate one or more boot programs. When IHS 100 is being powered for factory provisioning, processors 105 may execute one or more boot programs for use in factory provisioning the IHS 100. Also as described above, existing factory provisioning systems may rely on physical security of the IHS 100, but may omit use of cryptographic security during factory provisioning communications with the IHS.

As described in additional detail below, processor 105 may be factory provisioned by its manufacturer specifically for the manufacturer of IHS 100. In such instances, the manufacturer of IHS 100 may provide the manufacturer of processor 105 with a cryptographic key and boot code instructions that are to be burned directly to a memory of the processor, such as burned within one-time programmable fuses of the processor and such as burned (i.e., masked) in an onboard (i.e., on-chip) MROM of the processor. In some embodiments, the cryptographic key and boot code instructions that are burned to the processor may be provided by the manufacturer of the processor. This processor manufacturer may be a trusted entity of the manufacturer of the IHS 100, such that the manufacturer of the IHS may task the processor manufacturer with providing the cryptographic information and boot code. In some embodiments, the cryptographic key and/or boot code instructions that are burned to the processor may be provided be another entity that is trusted the manufacturer of the IHS.

Once a processor 105 that has been factory provisioning by its manufacturer in this manner is delivered to the manufacturer of IHS 100 and installed in the IHS, manufacture of the IHS is completed and the IHS 100 is subsequently powered to initiate factory provisioning of the IHS. As described in additional detail below, the boot code instructions provided by the manufacturer of IHS 100 and burned in the processor 105 may restrict the operation of the processor 105 to factory provisioning operations that configure programmable resources of the processor, where such operations received during factory provisioning are authenticated by the processor using the cryptographic key that was provided by the manufacturer of IHS 100 and burned in the processor 105.

As indicated in FIG. 2, a processor 105 chip installed in IHS 100 may include one or more distinct CPUs 105b-c. Each of the CPUs 105b-c may be a distinct general-purpose integrated circuits that are included in a single chip, such that processor 105 may support multi-core computing capabilities using these distinct CPUs. Upon IHS 100 being powered and booted, processor 105 may be powered and one of the CPUs 105b-c may be hard-coded to load and execute boot code. In some embodiments, CPUs 105b-c may load boot instructions that have been burned in ROM 105g of processor 105 during factory provisioning of the processor. As described in additional detail below, boot code may be burned in ROM 105g of the processor 105 during factory provisioning of the processor by its manufacturer.

In some embodiments, on-chip (i.e., onboard) ROM 105g of processor 105 may be a masked ROM (MROM) that is permanently burned using a masking process during the manufacturing of processor 105. In encoding data, such as the boot code and/or factory provisioning keys, to the MROM 105g, the data is physically etched onto the memory chip, thus permanently encoding the data in the onboard ROM 105g. During fabrication of processor 105, a photomask may be created that is used to burn the boot code and any other data to be permanently stored by ROM 105g. The photomask may then be used to project the data patterns onto the wafer from which the processor chip 105 is manufactured, thus defining and populating the memory cells of the ROM with this permanently burned data.

As illustrated, processor 105 may include volatile memory 105i, such as RAM, that may be utilized as cache memory that may be organized in to various levels of cache memories, each providing different speed and storage characteristics. Processor 105 may utilize volatile memory 105i as cache memory, thus providing a high-speed memory for storing instructions to be executed, as well as storing frequently accessed instructions and data used by the CPUs 105b-c. As illustrated, such onboard volatile memory 105i is distinct from system memory 110 that may be accessed by processor 105, as well as by other hardware components of the IHS 100. Processor 105 may also include one or more onboard persistent memory devices 105h, such as FLASH memory, that may be used by processor 105 to store critical data to be retained when the IHS 100 is powered off, such as certain boot code, BIOS instructions, firmware, system configurations, and boot data required for initializing the processor 105 and IHS 100 upon being powered.

Also as illustrated in FIG. 2, processor 105 may include a set communication ports 105f that are supported by the chipset of the processor and that are also supported by the IHS 100. As described, IHS 100 may include a network controller 140 that may include ethernet ports used in communicating via external networks and may also include fiber ports 155 used in internal and/or external PCIe networks. These network interfaces 140, 155 by be accessible via communication ports 105f supported by the chipset, where such ports may be permanently enabled and disabled through provisioning operations supported by the processor 105. The communication ports 105f supported by IHS 100 that may be accessed using the chipset of processor 105 may also include access by a JTAG (Joint Test Access Group) port 175 of the IHS. Upon connecting diagnostic tools to a physical connector of the IHS 100 that supports the JTAG debugging interface, a JTAG debug session may be utilized to retrieve data that has been made accessible to the JTAG interface by processor 105. For instance, an administrator may couple a diagnostic tool to a JTAG connector 175 of the IHS, where the diagnostic tool may retrieve data from JTAG registers supported by processor 105.

In some embodiments, processors 105 may maintain registers, such as a model-specific registers (MSRs), that may be updated to enable or disable the JTAG debugging interface. Some JTAG registers may be populated with data from the instruction pipeline of processor 105. In some instances, the JTAG interface supported by processor 105 may also provide diagnostic access to memory and devices that are connected to processor 105. In some instances, the JTAG interface supported by processor 105 may also include capabilities that are implemented in firmware for halting the operation of the processor, as well as for setting breakpoints that pause the operation of processor upon detecting a specified condition or upon reaching a particular instruction. Using these capabilities, administrators may be provided with capabilities for testing and debugging the operations of processor 105. However, if accessed by a malicious actor, this JTAG interface of processor 105 may be used to access information stored in the processor's memory, alter the behavior of firmware operating on processor 105, alter the behavior of devices coupled to processor 105 and install malicious firmware for operation by processor 105. Accordingly, as described in additional detail below, embodiments may require commands used in the factory provisioning of JTAG port 175 to be authenticated using the factory provisioning key that was burned to the processor 105 during its factory provisioning.

Through operation of the burned boot code, processor 100 may be restricted to only receiving and executing factory provisioning commands used in configuring programmable resources of the processor 100, such as programming of hardware registers that are burned by setting OTP fuses 105j. One-Time Programmable (OTP) fuses 105j may be used by processor 105 to securely store permanent data such that it cannot be altered after initial programming. OTP fuses 105j may be elements that may be electrically programmable through application of a voltage, such that an respective fuse may be set to a permanent state during the manufacturing of processor 105. Through such programming, OTP fuses 105j may be used to securely store critical information such as cryptographic keys and identification codes that are not to be altered during the life of the IHS 100. In embodiments, the programming of such resources of processor 105 during factory provisioning may be secured through authentication of received factory provisioning commands.

Through operation of the burned boot code, processor 100 may authenticate the received factory provisioning operations in order to determine whether these operations allowed. Upon receipt of an allowed factory provisioning operation, processor 105 may retrieve the burned factory provisioning key and use this key to authenticating a digital signature included along with the received factory provisioning operation. As indicated in FIG. 1, processor 105 may include a cryptographic module 105d in support of secure data handling by the processor. For instance, cryptographic module 105d may implement encryption and decryption operations on behalf of processor 105. In some embodiments, cryptographic module 105d may also implement hashing operations for use in verification of digital signatures, such as signed factory provisioning operations. In some embodiments, cryptographic module 105d may also implement key management operations, such that boot code burned to processor 105 may rely on such key management operations to securely retrieve and utilize the provided factory provisioning key and to utilize the key in validating received factory provisioning operations.

As indicated in FIG. 2, processor 105 may also include an application accelerator 105e. In some embodiments, application accelerator 105e may be used to enhance the performance of specific computational tasks supported by processor 105 by offloading them from the general-purpose CPUs 105b-c. Operations supported by an application accelerator 105e may include machine learning computations, such as neural network computations and training operations. In some instances, an application accelerator 105e may handle data compression and decompression, improving the efficiency of file storage and transmission operations. In some instances, an application accelerator 105e may be used to optimize graphics rendering for gaming and visualization applications.

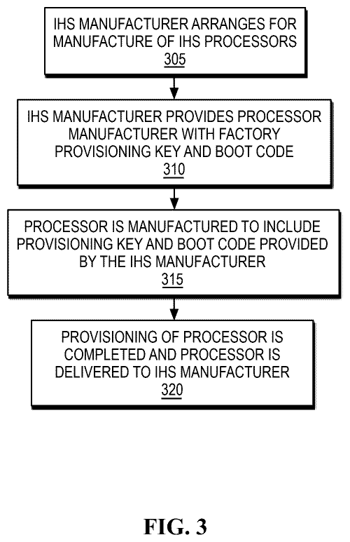

FIG. 3 is a flow chart diagram illustrating certain steps of a process according to various embodiments for factory provisioning of a processor in support of secure factory provisioning of an IHS. As described above, an IHS 100 may include one more processors 105. As indicated in FIG. 3, at 305, a manufacturer of IHSs may contract or otherwise arrange for manufacture and provisioning of processors 105 for installation in these IHSs. Whereas some processors installed in an IHS 100 may be considered off-the-shelf components that may be installed in IHSs from different manufacturers, processors 105 according to embodiments are manufactured and factory provisioned for a specific IHS manufacturer.

In some embodiments, at 310, the IHS 100 manufacturer provides the manufacturer of the processor 105 with information to be burned in the processor itself, where the burned information may then be used in the factory provisioning of the IHS 100, including for use in programming resources of the processor 105 during the factory provisioning of the IHS 100. As described above, in some embodiments, the cryptographic information and/or boot code burned to the processor may be provided by the manufacturer of the processor or by another entity that is trusted by the IHS manufacturer. As described, processor 105 may include various resources that may be programmed, in some instances permanently, through operations supported by the processor itself. Such operations for programming resources of the processor 105 may be used during factory provisioning of an IHS 100 in which the processor 105 is installed in order to uniquely configure the IHS, such as to burn cryptographic keys within OTP fuses 105j of the processor 105.

In some embodiments, the boot code that is burned to the processor, when executed by the processor, restricts the operations of processor 105 to the operations for programming resources of the processor itself, such as programming the state of OTP fuses 105j or the status of a JTAG port 175 of the IHS. In some embodiments, the manufacturer of IHS 100 provides the manufacturer of processor 105 with a cryptographic key for use by the manufacturer of IHS 100 during factory provisioning of the IHS 100 in which the processor 105 will be installed. In some embodiments, the burned cryptographic key may be generated by the manufacturer of the processor 105, and may also be provided to the manufacturer of the IHS for use in factory provisioning of the IHS.

In some embodiments, the cryptographic key may be a public key of a keypair of which the corresponding private key may be ultimately controlled by the manufacturer of IHS 100, whether this key is generated by the manufacturer of the IHS 100 or of the processor 105. In some embodiments, all processors 105 manufactured and factory provisioned for a manufacturer of IHS 100 may utilize the same factory provisioning key, serving as a fleet key for use by the manufacturer of IHS 100 during factory provisioning. In some embodiments, the provided factory provisioning key may be periodically rotated, thus serving as session keys that may be used for a particular duration or for provisioning a particular number of IHSs. In some embodiments, a different factory provisioning key may be provided for each unique processor that is manufactured and provisioned for the manufacturer of IHS 100, such as for processors included in DPUs 150a-b and hardware accelerators 160.

At 315, the manufacture and factory provisioning of the processor 105 continues with the boot code and the factory provisioning key being burned to the processor itself. In some embodiments, the provided boot code instructions may be fully or partially masked in onboard MROM 105g of the processor 105, such that these instructions are permanently burned to the processor. In some embodiments, the provided boot code instructions may be fully or partially stored in a boot sector of an onboard persistent memory 105h of the processor 105. In various embodiments, the factory provisioning key may be permanently burned within OTP fuses 105j, included in the mask of MROM 105g, or otherwise permanently stored by the processor 105 itself.

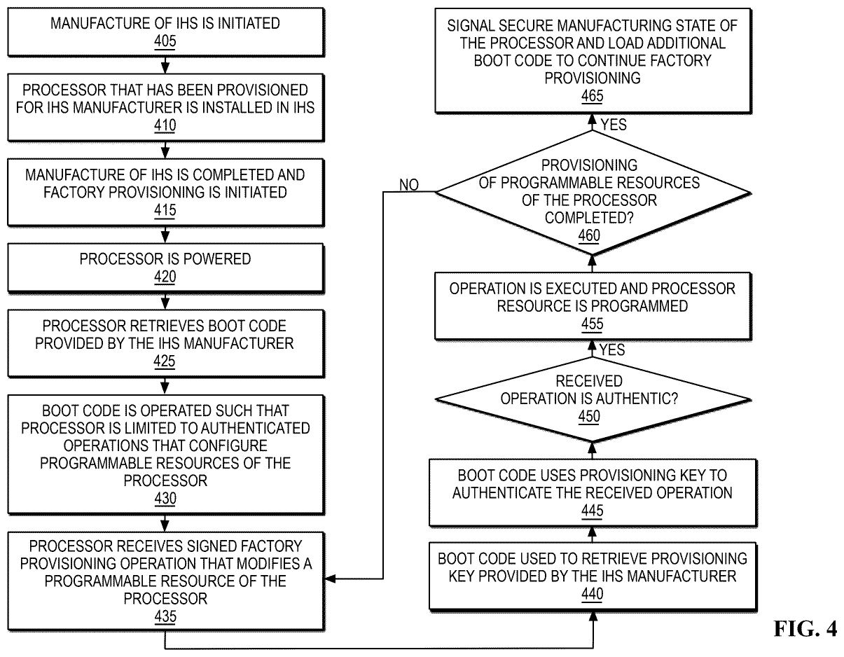

Once the provided factory provisioning key and boot code have been burned, at 320, the provisioning of processor 105 is completed and the processor is delivered to the IHS manufacturer for which the processor has been manufactured and provisioned. FIG. 4 is a flow chart diagram illustrating certain steps of a process according to various embodiments for secure factory provisioning of an IHS. Some embodiments may begin, at 405, with the factory assembly of an IHS 100, such as a rack-mounted server or a personal laptop. In some instances, an IHS may be manufactured using a factory process that includes multiple phases of assembly, validation and provisioning that must be completed before the IHS 100 is supplied to a customer. An IHS 100 may be purpose-built for a particular customer such that the IHS is assembled and provisioned according to specifications provided by the customer. The initial factory assembly of an IHS may include the selection of a chassis and the fastening of various hardware components to the selected chassis. The installed hardware components may include standard components and may also include specialized components that have been requested by a specific customer.

In embodiments, at 410, one of the hardware components installed in the IHS 100 is a processor 105 that has been manufactured and factory provisioned specifically for the manufacturer of IHS 100, such as described with regard to FIG. 3. Once this processor 105 and the other hardware of the IHS 100 has been installed, assembly of an IHS has been completed and the IHS may be subjected to manual and automated inspections that confirm the IHS has been properly assembled and does not include any defects. After confirming an IHS 100 has been assembled without any manufacturing defects, at 415, factory provisioning of the IHS may be initiated.

The newly assembled IHS 100 may be moved to a provisioning facility within the factory or to a different facility for the initial factory provisioning of the IHS. At the provisioning facility, at 420, the IHS 100 is powered, thus also powering the processor 105. Upon being powered, the processor 105 executes hard-coded instructions for initialization of the processor itself and the retrieval of boot code. As described with regard to FIG. 3, these hard-coded instructions executed by processor 105 may result, at 425, in the processor 105 loading the boot code, such as boot code masked in MROM 105g of the processor 105.

At 430, the processor 105 executes the boot code causing a factory provisioning program to be operated by the processor 105, where this factory provisioning program limits the operations of the processor to authenticated operations that configure resources of the processor 105 itself, such as operations used in programming of OTP fuses 105j. Embodiments may also support additional operations that provide status and identity information for the processor 105, but the only factory provisioning operations that are supported by the provided boot code being run by the processor 105 are operations that configure resources of the processor.

With the processor 105 operating the burned boot code, at 435, the processor 105 receives a signed command for programming or otherwise configuring resources of the processor, such as a command directing the processor 105 to burn a cryptographic key within the OTP fuses 105j of the processor, or such as a command directing the processor 105 to disable access to the processor by a JTAG port 175 of the IHS. Upon receipt of a signed factory provisioning command, at 440, the provided boot code retrieves the factory provisioning key of the IHS manufacturer that was burned to the processor 105, such as described with regard to FIG. 3.

As described, the factory provisioning key burned to the processor 105 may be a public key. At 445, the boot code may utilize such a public key to validate the signature included in the received command. In scenarios where the received command is authentic, such commands are signed by the manufacturer of IHS 100 using the private key of the keypair corresponding to the factory provisioning public key that has been burned in the processor 105. In particular, the boot code may use the factory provisioning public key to decrypt the signature included in the command, thus resulting in a decrypted hash value. If the boot code determines that the resulting hash corresponds to its own hash calculation generated from the received command, the boot code is assured of the integrity of the received command and the authenticity of operation as signed by the holder of the private key corresponding the burned public key. In this manner, at 450, the boot code may authenticate each received factory provisioning operation using the boot code and factory provisioning key that was provided by the manufacturer of IHS 100, or provided to the manufacturer of the IHS 100 by a trusted entity, such as the manufacturer of the processor 105.

Received operations that are determined as authentic may then be executed, at 455, by the processor 105. In some instances, the received operations may be used in programming OTP fuses 105j or other permanently programmable resources of the processor 105 itself. In some instance, the received operations may be used in enabling or disabling access to the processor 105 itself, or access to protected regions of processor 105, by physical ports supported by the processor, such as enabling or disabling access to the processor by JTAG ports 175, PCIe ports 155, ethernet ports 140, sideband management 130 ports used by remote access controller 130, etc.

Any number of received operations may be validated in this manner using the provided boot code and factory provisioning key. In some embodiments, such authenticated factory provisioning operations may be used to burn random numbers in OTP fuses 105j of the processor 105, such as for use as cryptographic seed values. In some embodiments, such authenticated factory provisioning operations may be used to burn key pairs, individual private keys, individual public keys, symmetric keys, tokens, or other cryptographic values in the OTP fuses 105j of the processor 105. In some embodiments, such authenticated factory provisioning operations may be used to permanently enable or disable capabilities of the processor 105, such as disabling or enabling the JTAG 175 port supported by the processor 105, or such as disabling/enabling other ports or interfaces supported by processor 105.

The authentication and execution of factory provisioning operations may continue until, at 460, the processor 105 receives a signed operation directing the processor 105 to load and execute a subsequent boot application, such as an application by which factory provisioning of the IHS 100 will be continued. In some embodiments, this boot application may be stored within one of the persistent memories 105h of the processor 105. In some embodiments, the subsequent boot application may be transmitted to the processor 105 via the JTAG 175 interfaces supported by the processor 105. In some embodiments, the subsequent boot application may be burned within the MROM 105g, and may thus have been factory provisioned by the manufacturer of processor 105.

Upon the processor 105 receiving such a command to load a subsequent boot application, the signature provided along with the command is validated by the processor 105 using the factory-provisioned key in order to validate the integrity of the instructions of this subsequent boot application and the authenticity of the command itself as signed by the manufacturer of the IHS. If the subsequent boot application is validated, at 465, the processor 105 exits the operation of the provided boot code and signals that the processor 105 is now in a secure manufacturing state, with the security of the processor 105 established and the processor 105 now burned to include cryptographic information by which to utilize secured communications throughout the remainder of the factory provisioning process. With the processor 105 in this secured manufacturing state, factory provisioning may continue. In some instances, the remaining factory provisioning may include stages for loading of firmware, configuring hardware components, and installing an operating system and other software. All such factory provisioning operations may be conducted using communications secured by the factory provisioning key that was burned in the processor 105 during its factory provisioning.

### * * *

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS) comprising:
one or more processors, wherein a first of the processors is factory provisioned by a manufacturer of the first processor by burning a key and boot code to the first processor;
a memory device coupled to the first processor, the memory device storing the boot code that, upon loading and execution by the first processor upon initial powering of the first processor for factory provisioning of the IHS, causes the first processor to:
restrict the first processor to authenticated factory provisioning operations that program resources of the first processor until the first processor is transitioned to a secured manufacturing state; and
use the key burned in the first processor to authenticate received factory provisioning operations.

2. The IHS of claim 1, wherein the key is provided by a manufacturer of the IHS and the boot code is provided by a manufacturer of the IHS or by the manufacturer of the first processor.

3. The IHS of claim 1, wherein the operations that program resources of the first processor comprise operations that permanently set one or more one-time programmable fuses of the first processor.

4. The IHS of claim 1, wherein the operations that program resources of the first processor comprise operations that enable or disable a communication interface of the first processor.

5. The IHS of claim 4, wherein the operations that enable or disable a communication interface of the first processor comprise enabling or disabling a JTAG interface supported by the first processor.

6. The IHS of claim 1, wherein the boot code is burned to the first processor by masking the boot code in a ROM of the first processor.

7. The IHS of claim 1, wherein the key comprises a public key of an asymmetric cryptographic keypair controlled by the manufacturer of the IHS.

8. The IHS of claim 7, wherein the key is burned to the first processor by permanently setting one or more one-time programmable fuses of the first processor.

9. The IHS of claim 1, wherein execution of the boot code by the first processor further causes the first processor to detect receipt of a signed operation directing the first processor to load additional boot code.

10. The IHS of claim 9, wherein the first processor is transitioned to the secured manufacturing state upon validation of the additional boot code against a signature included in the signed operation.

11. The IHS of claim 10, wherein the signature included in the signed operation is validated using the key burned to the first processor.

12. A method for secure factory provisioning of an Information Handling System (IHS), the method comprising:
burning a key and boot code to a processor by the manufacturer of the processor;
installing the processor in the IHS during manufacture of the IHS;
loading the boot code burned to the processor upon initial powering of the processor for factory provisioning of the IHS;
through operation of the loaded boot code, restricting the processor to authenticated factory provisioning operations that program resources of the processor until the processor is transitioned to a secured manufacturing state; and
using the key burned in the processor to authenticate received factory provisioning operations.

13. The method of claim 12, wherein the operations that program resources of the processor comprise operations that permanently set one or more one-time programmable fuses of the processor.

14. The method of claim 12, wherein the boot code is burned to the processor by masking the boot code in a ROM of the processor.

15. The method of claim 12, wherein the key comprises a public key of a cryptographic keypair controlled by the manufacturer of the IHS.

16. The method of claim 12, further comprising:
detecting receipt of a signed operation directing the processor to load additional boot code; and
transitioning the processor to the secured manufacturing state upon validation of the additional boot code using the key and burned to the processor.

17. A computer-readable storage device of a processor having boot code stored thereon for secure factory provisioning of an Information Handling System (IHS) in which the processor is installed, and wherein, upon loading and execution of the boot code by the processor upon initial powering of the processor for factory provisioning of the IHS, execution of the boot code causes the processor to:
restrict the processor to authenticated factory provisioning operations that program resources of the processor until the processor is transitioned to a secured manufacturing state; and
use a key burned in the processor to authenticate received factory provisioning operations, wherein the key is burned to the processor by its manufacturer.

18. The computer-readable storage device of claim 17, wherein the operations that program resources of the processor comprise operations that permanently set one or more one-time programmable fuses of the processor.

19. The computer-readable storage device of claim 17, wherein the boot code is burned to the processor by masking the boot code in a ROM of the processor.

20. The computer-readable storage device of claim 17, wherein the key comprises a public key of a cryptographic keypair controlled by the manufacturer of the IHS.
